(19) United States
(12) Patent Application Publication
(10) Pub. No.: US 2005/0259591 A1
(43) Pub. Date: Nov. 24, 2005

(54) Providing status information in a communications system

(76) Inventors: Aaron T. Moore, Plainfield, NJ (US); Wen-Pin Lin, Morristown, NJ (US)

Correspondence Address: WILLIAMS, MORGAN & AMERSON/LUCENT, 10333 RICHMOND, SUITE 1100, HOUSTON, TX, 77042, US

(21) Appl. No.: 10/402,569

(22) Filed: Mar. 28, 2003

(51) Int. Cl. H04L 12/26

(52) U.S. Cl. 370/252; 370/224

(57) ABSTRACT

A method and an apparatus for providing status information on a substantially real-time basis in a communications system. The method comprises determining usage as a function of capacity of one or more connections of a base station. The one or more connections are capable of carrying data to and from the base station. The method further comprises displaying the usage for the one or more connections of the base station in substantially real-time.

### BACKGROUND OF THE INVENTION

1 . Field of the Invention

This invention relates generally to a communications system, and, more particularly, to providing status information, such as data traffic load or user transmission rate information, on a substantially real-time basis in a wireless communications system.

2 . Description of the Related Art

The phenomenal growth of Information Technology and the Internet has created a need for a high-performance wireless Internet technology. Communications devices, such as personal digital assistants and smart phones, enable users to communicate wirelessly while on the move. One technology that offers high-speed, high-capacity wireless Internet connectivity is Phase 1 Evolution Data Only (1xEV-DO).

1xEV-DO is based on Code Division Multiple Access (CDMA) principles. 1xEV-DO supports a peak data rate as high as 2.4 Mpbs for a single user in the forward direction, and a peak rate of 154 Kbps in the reverse direction. 1xEV-DO supports asymmetric data rates on the forward and reverse links because the wireless communications devices typically receive larger amounts of data from the wireless networks than they transmit in the reverse direction. 1xEV-DO may be utilized with any Internet Protocol (IP) network that conforms to TIA/EIA/IS835 (Wireless IP network interface), IA/EIA/TSB-115 (Wireless IP Architecture), and TIA/EA/IS-2001 (Interoperability Specifications for CDM2000 Network Access Interfaces) standards.

A typical 1xEV-DO configuration includes one or more base stations that are coupled to a central office through one or more routers. A service provider may couple a base station (BTS) to a router by, for example, a plurality of T1 or E1 facilities to provide a peak forward link data rate of 2.4 Mbps. Supporting a plurality of T1/EI facilities through a base station, however, can give rise to load balancing issues, as some facilities may be overloaded while others remain virtually unused. Facilities that are disproportionately imbalanced can adversely affect the quality of the communications between devices in a communications system, and can even lead to operation failure if not timely addressed. However, troubleshooting communication problems, such as improper load balance, in a communications system may be difficult without real-time status information of the various components of the communication system.

The present invention is directed to overcoming, or at least reducing, the effects of, one or more of the problems set forth above.

### SUMMARY OF THE INVENTION

In one embodiment of the present invention, a method for providing status information on a real-time basis in a communications system is provided. The method comprises determining usage as a function of capacity of one or more connections of a base station. The one or more connections are capable of carrying data to and from the base station. The method further comprises displaying the usage for the one or more connections of the base station in substantially real-time.

In a further embodiment of the present invention, an article comprising one or more machine-readable storage media containing instructions for providing status information on a real-time basis in a communications system is provided. The one or more instructions, when executed, enable the processor to request load information associated with one or more connections adapted to transmit data from a base station to a remote location, wherein the request is encapsulated in a data packet, receive the load information, and display the load information associated with the one or more connections in substantially real-time.

In a further embodiment of the present invention, a system for providing status information on a real-time basis in a communications system is provided. The communications system comprises a router communicatively coupled to a base station by one or more connections and a control unit. The control unit is adapted to determine a load level of the one or more connections that are adapted to transmit data to a remote location and display a usage for at least one of the two or more connections in substantially real-time.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a data communications system, in accordance with one embodiment of the present invention;

FIG. 2 depicts a block diagram of one embodiment of the communications system of FIG. 1;

FIG. 3 is a flow diagram of a method that may be implemented by a performance monitor system of the communications systems of FIGS. 1 and 2, in accordance with one embodiment of the present invention; and

FIGS. 4, 5A-B, and 6 illustrate exemplary graphs that may be produced by the performance monitor system of the communications system of FIGS. 1 and 2.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

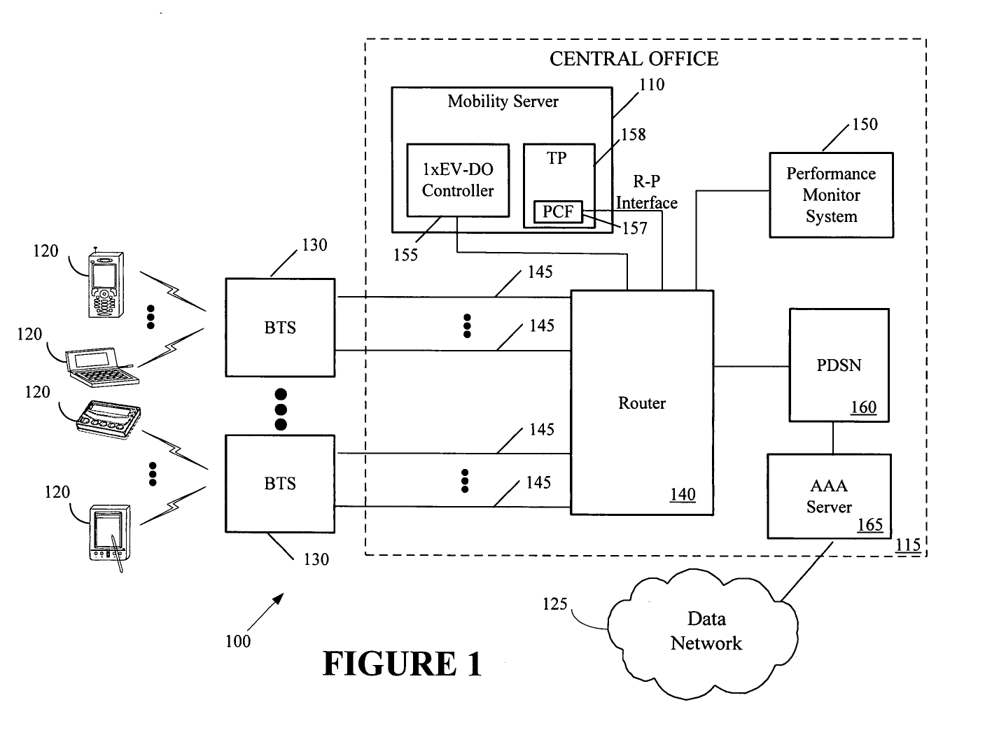

Turning now to the drawings, and specifically referring to FIG. 1, a communications system 100 is illustrated, in accordance with one embodiment of the present invention. For illustrative purposes, the communications system 100 of FIG. 1 is a 1xEV-DO system, although it should be understood that the present invention may be applicable to other systems that support data and/or voice communication. The communications system 100 includes a mobility server 110 located at a central office 115 that allows one or more access terminals 120 to communicate with a data network 125, such as the Internet, through one or more base stations (BTS) 130. The access terminal 120 may include one of a variety of devices, including cellular phones, personal digital assistants (PDAs), laptops, digital pagers, wireless cards, and any other device capable of accessing the data network 125 through the BTS 130.

In one embodiment, each BTS 130 may be coupled to a router 140 by one or more connections 145, such as T1/EI lines or circuits, ATM circuits, cables, and optical digital subscriber lines (DSLs). In the illustrated embodiment, the communications system 100 includes a performance monitor (PM) system 150 that allows a user, such as a service provider, to monitor a variety of useful information in substantially real-time. For example, the PM system 150 allows a user to monitor the load, and hence the load balance, of the connections 145 (e.g., TI/EI circuits) of the BTS 130, the service data rate of one or more access terminals 120, and/or the service data rate of each sector supported by the BTS 130. It should be understood that the act of monitoring information in “real-time” may involve the inherent delays associated with transmitting, receiving, and displaying the information. As such, “real-time” information may be monitored in “substantially” real-time. A service provider, based on the real-time information, can analyze the performance of the selected components of the communications system 100 to troubleshoot communication problems, as well as to determine if the selected components should be upgraded (or replaced) to support the current data traffic load.

The mobility server 110 of FIG. 1 generally provides replication, communications, runtime, and system management services. The mobility server 110, in the illustrated embodiment, includes a 1xEV-DO controller 155, and a packet control function (PCF) module 157 embedded in a traffic processor (TP) module 158. The 1xEV-DO controller 155 supports 1xEV-DO service in the communications system 100 of FIG. 1, and the traffic processor module 158 handles calling processing functions, such as setting and terminating a call path. The traffic processor module 158, in one embodiment, is capable of determining a data transmission rate on the forward and/or reverse link for each user (or access terminal 120) and for each sector supported by the BTS 130. The PCF module 157, in one embodiment, buffers data received from a packet data service node (PDSN) 160 (described below), as well as maintains data during the dormant state. The PCF module 157 may support communications through an Open R-P (A10-A11) interface, where the A10 interface may be utilized for packet traffic and the A11 interface for signaling. Because the Open R-P interface is well-known to those skilled in the art, it is not described in detail herein.

In the illustrated embodiment, the PDSN 160 is coupled between the router 140 and an authentication, authorization, and Accounting (AAA) server 165. The PDSN 160 generally establishes secure communications to the access terminal 120 through security information provided by the AAA server 165. In one embodiment, the PDSN 160 records data usage, receives accounting information from the PCF module 157 over the Open R-P (A10-A11) interface, correlates the data to generate the accounting information, and relays the correlated information to the AAA server 165. The PDSN 160 may also maintain a serving list and a unique link layer identifier for the access terminals 120.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

It should be understood that the configuration of the communications system 100 of FIG. 1 is exemplary in nature, and that fewer or additional components may be employed in other embodiments of the communications system 100. For example, in one embodiment, the system 100 may include a network management system (not shown) that provides operation, administration, maintenance, and provisioning functions for a 1xEV-DO network. Additionally, the system 100 may include one or more multiplexers (not shown) connected between the BTS 130 and the router 140 for performing protocol translations. In one embodiment, the PDSN 160 may be coupled to the data network 125 without the AAA server 165. Similarly, other components may be added or removed from the communications system 100 of FIG. 1 without deviating from the spirit and scope of the invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

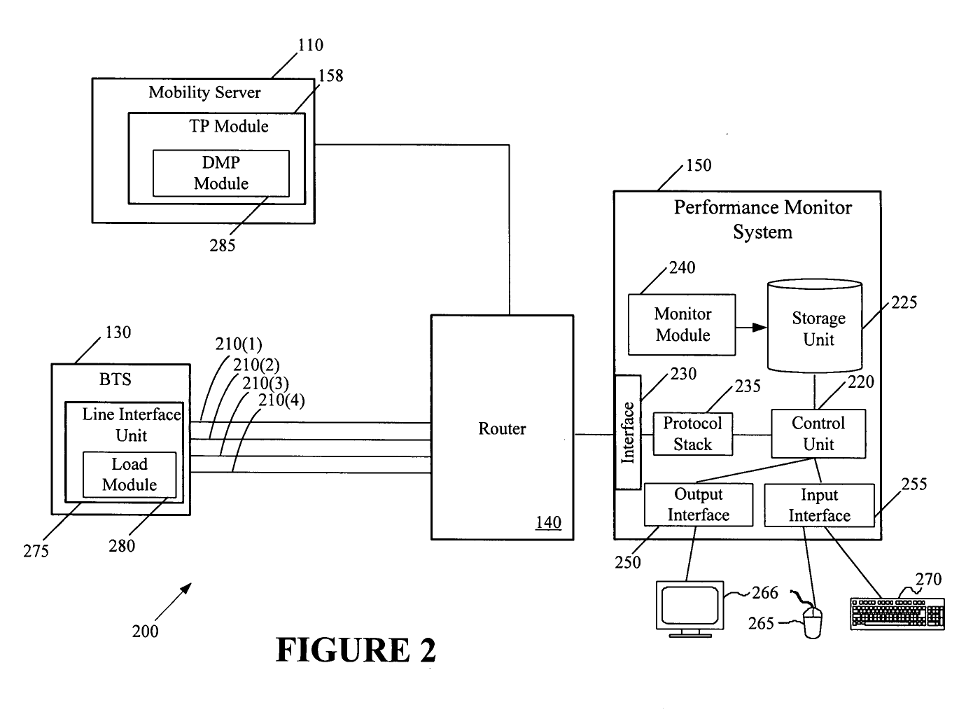

Referring now to FIG. 2, a block diagram of one embodiment of a communications system 200 is illustrated, in accordance with one embodiment of the present invention. The system 200 includes the PM system 150 coupled to the router 140. In the illustrated embodiment, the router 140 is further coupled to the BTS 130 by four T1 circuits (or lines) 210(1-4). For ease of illustration, only one BTS 130 is illustrated, although it should be understood that the communications system 200 may include more than one BTS 130.

The PM system 150 includes a control unit 220 that is communicatively coupled to a storage unit 225. The PM system 150 also includes a network interface 230 that provides the communications interface to the router 140. Associated with the network interface 230 may be a network protocol stack 235, with one example being a UDP/IP (User Datagram Protocol/Internet Protocol) stack. UDP is described in RFC 768, entitled “User Datagram Protocol,” dated August 1980. In another embodiment, the network protocol stack 235 may be a Transmission Control Protocol/Internet Protocol (TCP/IP) stack. In one embodiment, both inbound and outbound packets may be passed through the network interface 230 and the network protocol stack 235.

The PM system 150 includes a monitor module 240 that is storable in the storage unit 225. The monitor module 240 is capable of providing requests and receiving data via the network interface 230. In one embodiment, the monitor module 240 allows a user to monitor, in substantially real-time, the load of each T1 circuit 210(1-4) in the BTS 130, the service data rate of one or more access terminals 120 (see FIG. 1) that access the data network 125 through the BTS 130, and/or the service data rate of each sector that is supported by the BTS 130.

In one embodiment, the PM system 150 includes an output interface 250 and an input interface 255. The output interface 250 may be capable of interfacing with a display device 266 to display information thereon. The input interface 255 may be capable of interfacing with input devices, such as a mouse 265 and/or a keyboard 270, to allow the user to input information into the PM system 150.

The BTS 130 includes a line interface unit 275 and a load module 280. The load module 280, in the illustrated embodiment, receives requests from the monitor module 240 of the PM system 150 and responds to the requests through the line interface unit 275. The monitor module 240, for example, may request the load module 280 to provide the data traffic on (or bandwidth usage of) one or more of the T1 circuits 210(1-4). The amount of data traffic may be determined, in one embodiment, by calculating a volume of data packets transmitted over a particular T1 circuit 210 at a given time or a given period. The exchange of information between the monitor module 240 and the load module 280 may occur over TCP/IP or UDP/IP. If the communications system 200 includes more than one BTS 130, then, in one embodiment, each BTS 130 may include the load module 280 to provide load information for its respective T1 circuits 210. The number of T1 circuits 210 supported by a given BTS 130 may vary from one BTS 130 to another.

In the illustrated embodiment, the traffic processor module 158 of the mobility server 110 includes a data manager processor (DMP) module 285 that receives requests from, and responds to, the monitor module 240 of the PM system 150 over an open network protocol, such as TCP/IP or UDP/IP. The monitor module 240, for example, may request the load module 280 to provide the data transmission rate on a user basis or a sector basis.

The various components of the communications system 200 of FIG. 2, such as the PM system 150 and the mobility server 110, may be coupled to the router 140 in a variety of suitable ways, including over an Ethernet network, ATM connection, Token Ring network, or any other connection capable of supporting the Internet Protocol.

It should be understood that the configuration of the communications system 200 of FIG. 2 is exemplary in nature, and that a variety of other configurations may be employed in other embodiments. For example, in one embodiment, the monitor module 240 may be implemented in one of the access terminals 120 (see FIG. 1), and, as such, the user of the access terminal 120 may wirelessly access information such as the load on one or more of the T1 circuits 210, the data rate for a given user(s), and/or the data rate for a given sector(s). Additionally, in an alternate configuration, the PM system 150 may receive load balance information regarding one or more of the T1 circuits 210 from the mobility server 110 rather than from the BTS 130.

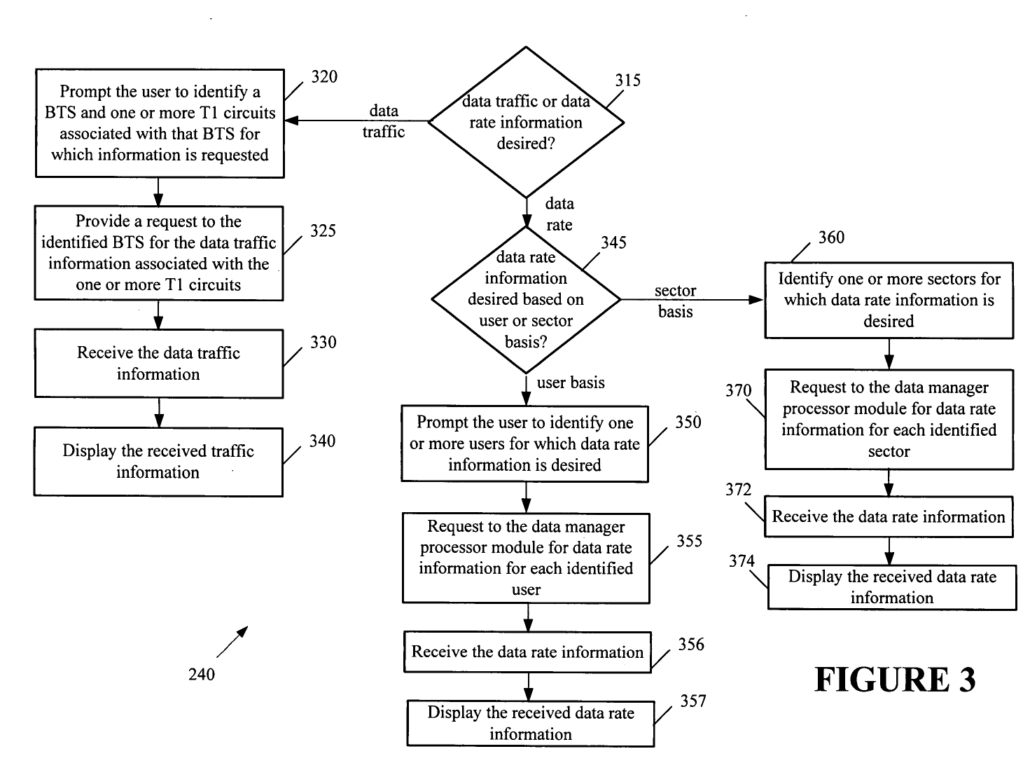

Referring now to FIG. 3, a flow diagram of the monitor module 240 is illustrated, in accordance with one embodiment of the present invention. For ease of illustration, the flow diagram of FIG. 3 is described in the context of the communications system 200 of FIG. 2. The monitor module 240 determines (at 315) whether the user desires data traffic or data rate information. In one embodiment, the monitor module 240 may prompt the user to select either to display the amount of data traffic on the T1 circuits 210 or to display data rates by user or sector. Based on the user input, the monitor module 240 can, for example, determine (at 315) the type of information sought by the user.

Assuming that the user desires to view the amount of data traffic (or load) on the T1 circuits 210, the monitor module 240 prompts (at 320) the user to identify a BTS 130 and one or more T1 circuits 210 associated with the BTS 130 for which load information is requested. The monitor module 240 requests (at 325) the BTS 130 that is identified by the user (at 320) for the data traffic associated with the one or more T1 circuits 210. As noted earlier, in one embodiment, the request may be provided by the monitor module 240 to the BTS 130 over TCP/IP or UDP/IP network protocol.

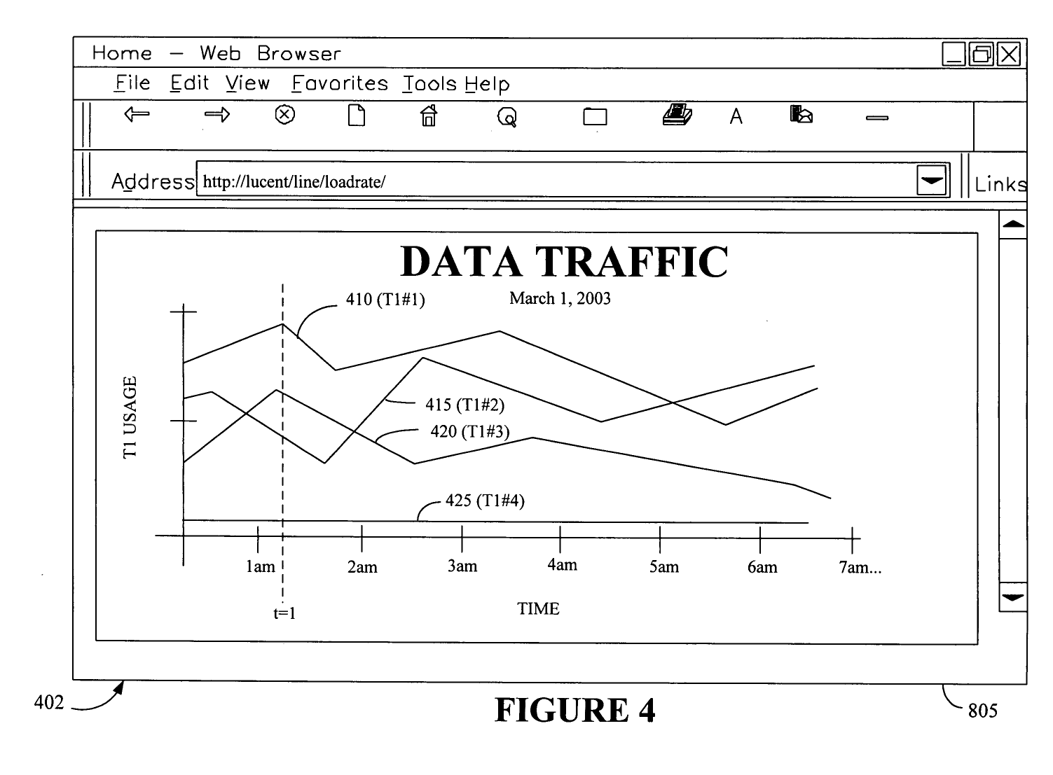

In response to the request, the load module 280 of the BTS 130 provides, and the monitor module 240 receives (at 330), the requested data traffic information. The monitor module 240 displays (at 340) the received data traffic information on the display 266 (see FIG. 2) of the PM system 150. The data traffic information may be displayed in any manner desirable by the user, including in graphical form. Additionally, a color scheme may be employed in conjunction with displaying the data traffic information to denote different traffic loads (e.g., the green color may indicate a light load, and the red color may indicate that the T1 is operating at maximum capacity). In one embodiment, the monitor module 240 may display the data traffic information in a hyper text markup language (HTML) file, as shown in FIG. 4, so that it may be readily viewed by a local or remotely located web browser application.

FIG. 4 illustrates a web browser window 402 in which an exemplary data traffic graph is illustrated for each of the four T1 circuits 210(1-4) of the BTS 130. In the exemplary data graph chart, the x-axis represents time and the y-axis represents the usage of the T1 circuits 210(1-4). In particular, graphs 410, 415, 420, 425 illustrate the load variance of the respective T1 circuits 210(1-4) over time. In FIG. 4, at time t=1, the exemplary graphs 410, 415, 420, 425 show that the first T1 circuit 210(1) is more heavily utilized than the other three T1 circuits 210(2-4). FIG. 4 further illustrates that the fourth T1 circuit 210(4) is the least utilized relative to the other three T1 circuits 210(1-3).

The information of FIG. 4 may be presented in other graphical forms as well, including in the form of a bar chart, pie chart, and the like. The graphs 410, 415, 420, 425 of FIG. 4 allow a user to readily monitor the data traffic in substantially real-time and can assist the user in troubleshooting problems in the communication systems 100, 200 (see FIGS. 1 and 2). For example, if a user of the access terminal 120 (see FIG. 1) reports a problem with a slow connection, the graphs 410, 415, 420, 425 of FIG. 4 may allow a service provider to quickly and efficiently determine if the fault lies with an overloaded T1 circuit 210(1-4) or with some other component in the systems 100, 200. Additionally, the information presented by the graphs 410, 415, 420, 425 may be utilized by the service provider to determine if the load balance is evenly distributed among the various T1 circuits 210(1-4). Furthermore, the information presented by the graphs 410, 415, 420, 425 may also be utilized to determine if the current configuration is adequate to support the user demand. Thus, a service provider may utilize the substantially real-time load information to determine if the current number of T1 circuits 210(1-4) is adequate to support the data traffic load for a given base station 130. For example, if the graphs 410, 415, 420, 425 show that all of the T1 circuits 210(1-4) are operating at near maximum capacity, then more T1 circuits 210(1-4) may be needed to support the users desiring data access. The information presented by the graphs 410, 415, 420, 425 may also be utilized by the service provider to identify peak traffic times in a given day.

Referring again to FIG. 3, if the monitor module 240 determines (at 315) that information regarding service data rate is desired, then the monitor module 240 determines (at 345) whether information regarding the user data transmission rate or sector data transmission rate is desired. If the user data transmission rate is desired, then the monitor module 240 prompts (at 350) the user to identify one or more users for whom data transmission rate information is desired. The monitor module 240 requests (at 355) the data manager processor module 285 of the mobility server 110 to provide the data rate for each of the users previously identified (at 350). The data transmission rates may be requested for the forward link (from the BTS 130 to the user) and/or for the reverse link (from the user to the BTS 130). As noted earlier, in one embodiment, the request may be provided by the monitor module 240 to the mobility server 110 over TCP/IP or UDP/IP network protocol.

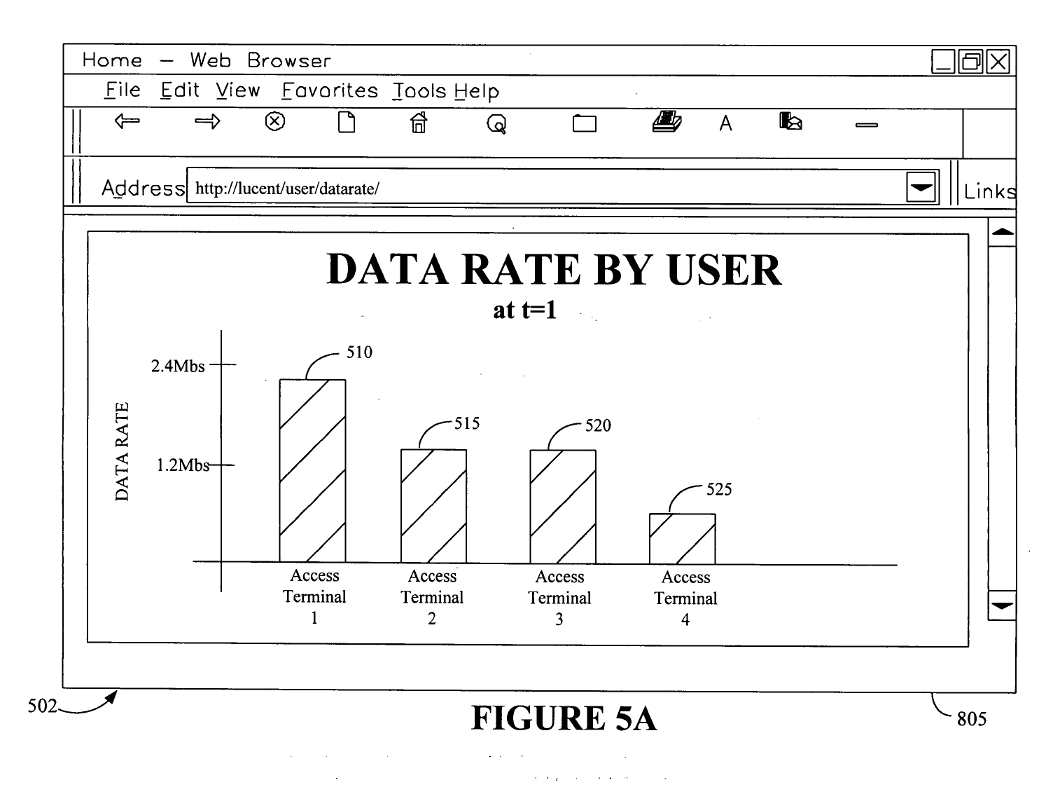

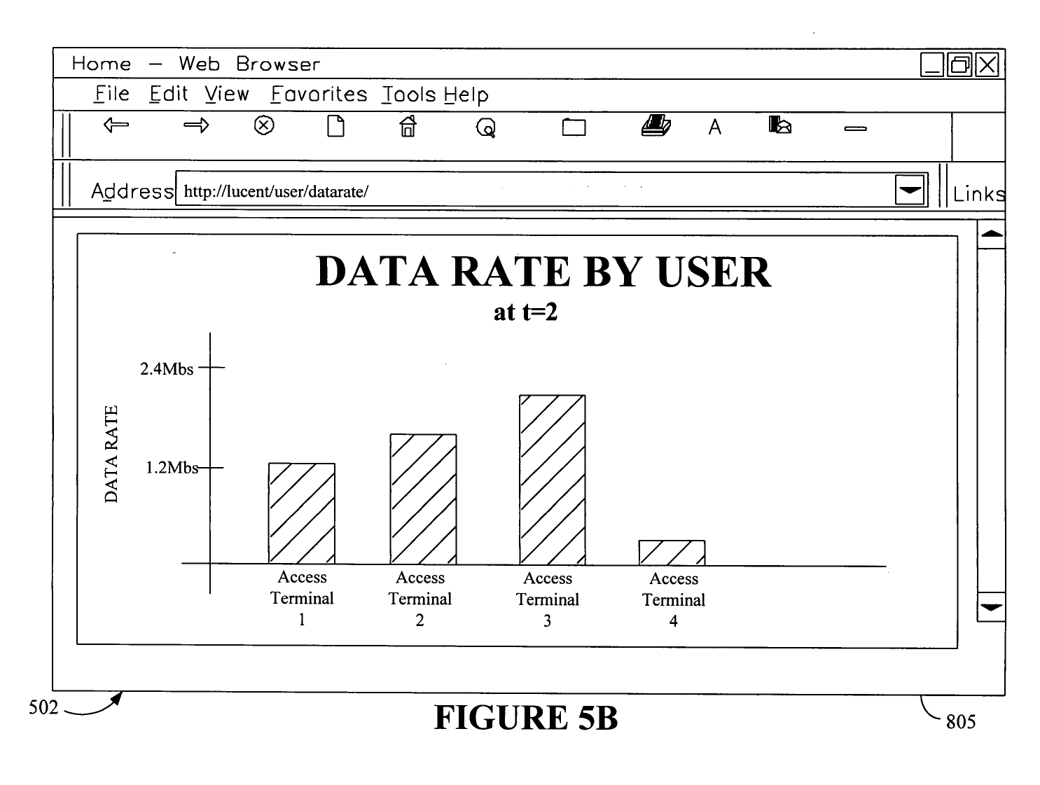

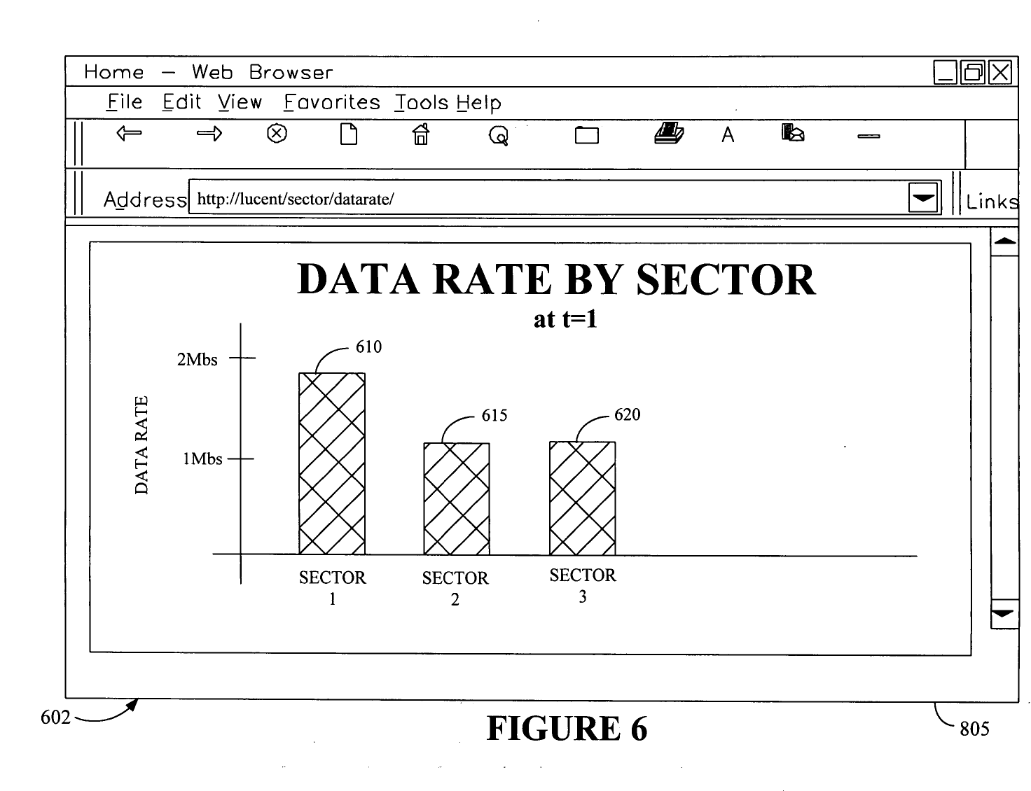

In response to the request, the data manager processor module 285 provides, and the monitor module 240 receives (at 356), the requested user data transmission rates. The monitor module 240 displays (at 357) the received user data transmission rates on the display 266 (see FIG. 2) of the PM system 150. The user data transmission rates may be displayed in any manner desirable by the user, including in graphical form. In one embodiment, the monitor module 240 may display the user data transmission rates in a hyper text markup language (HTML) file, as shown in FIGS. 5A-5B, so that it may be readily viewed by a local or a remotely located web browser application.

FIG. 5A illustrates a web browser window 502 in which an exemplary graph shows the current data transmission rate of the various (four in the illustrated example) access terminals 120 communicating with the BTS 130 at a given time, t=1. In the exemplary data graph chart, the x-axis represents the four access terminals 120 and the y-axis represents the data transmission rate on the forward link (from the BTS 130 to the user). In FIG. 5A, the bar graphs 510, 515, 520, 525 illustrate the data transmission rate of the four respective access terminals 120 at a given time, t=1. In particular, the exemplary graphs 510, 515, 520, 525 respectively show that, at t=1, the data transmission rate of the first access terminal 120 is close to 2.4 Mbs, the second and third access terminals 120 is on or about 1.2 Mbs, and the third access terminal 120 is about 0.6 Mbs. The data represented by the graph of FIG. 5A may be continuously updated, in one embodiment, as new data transmission rates become available. FIG. 5B, which represents an updated form of FIG. 5A, illustrates new exemplary data transmission rates of the access terminals 120 at time t=2. In the example shown in FIG. 5B, as can be seen, the data transmission rates of the first and third access terminals 120 have changed, while the rates of the other access terminals 120 have remained substantially the same.

Referring again to FIG. 3, if the monitor module 240 determines (at 345) that information regarding the sector data transmission rate is desired, then the monitor module 240 prompts (at 360) the user to identify one or more sectors for which data rate information is desired. The data transmission rates may be requested for the forward link (from the BTS 130 to the user) and/or for the reverse link (from the user to the BTS 130). The monitor module 240 requests (at 370) the data manager processor module 285 of the mobility server 110 to provide the data rate for each of the sectors previously identified (at 360). The number of sectors defined for a given cell depends on the particular configuration. Generally, a 3-sector or a 6-sector is employed in CDMA communication systems. In one embodiment, the request may be provided by the monitor module 240 to the mobility server 110 over TCP/IP or UDP/IP network protocol.

In-response to the request (at 370), the data-manager processor module 285 provides, and the monitor module 240 receives (at 372), the requested sector data transmission rates. The monitor module 240 displays (at 374) the received sector data transmission rates on the display 266 (see FIG. 2) of the PM system 150. The sector data transmission rates may be displayed in any manner desirable to the user, including in graphical form. In one embodiment, the monitor module 240 may display the sector data transmission rates in a hyper text markup language (HTML) file, as shown in FIG. 6, so that it may be readily viewed by a local or a remotely located web browser application.

FIG. 6 illustrates a web browser window 602 in which an exemplary graph shows the current data transmission rate for each sector (three in the illustrated example) at a given time, t=1. In the exemplary data graph chart, the x-axis represents the three sectors and the y-axis represents the data transmission rate. In FIG. 6, the bar graphs 610, 615, 620 illustrate the data transmission rate of the three respective sectors. In particular, the exemplary graph 610 shows that, at t=1, the data transmission rate of the first sector is approximately 2.0 Mbs, while the graphs 615, 620 show that the data transmission rates of the second and third sectors are both approximately 1.0 Mbs. In one embodiment, the exemplary graph of FIG. 6 may be updated as new data transmission rates become available.

The information shown in FIGS. 5A, 5B, and 6 may be presented in other graphical forms as well, including in the form of a bar chart, pie chart, and the like. Presenting the data rates in a graphical format enables the service provider to readily evaluate the connection rate of individual access terminals 120 or sectors.

Those skilled in the art will appreciate that the various system layers, routines, or modules illustrated in the various embodiments herein may be executable control units (such as the control unit 220 (see FIG. 2)). The control unit 220 may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit 220 causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
determining usage as a function of capacity of one or more connections of a base station, wherein the one or more connections are capable of carrying data to and from the base station; and
displaying the usage for the one or more connections of the base station in substantially real-time.

2. The method of claim 1, wherein determining the usage comprises transmitting a request to the base station to provide the usage, wherein the request is transmitted over an Internet Protocol network.

3. The method of claim 2, wherein transmitting the request comprises transmitting the request to the base station via a network router.

4. The method of claim 1, wherein displaying the usage comprises displaying the usage in graphical format.

5. The method of claim 4, wherein displaying the usage comprises displaying the usage using a color scheme based on the level of usage.

6. The method of claim 1, further comprising receiving and displaying data transmission rate information associated with one or more access terminals that are adapted to communicate with the base station, wherein receiving the data transmission rate information comprises receiving the data rate information over an Internet Protocol network.

7. The method of claim 1, further comprising adjusting a load balance among the one or more connections based on the usage of the one or more connections of the base station.

8. The method of claim 1, wherein the base station supports a three-sector configuration, further comprising receiving and displaying data transmission rate information associated with at least one of the three sectors.

9. The method of claim 1, further comprises:
determining usage as a function of capacity of one or more connections of a second base station, wherein the one or more connections are capable of carrying data to and from the second base station; and
displaying the usage for the one or more connections of the second base station in substantially real-time.

10. An article comprising one or more machine-readable storage media containing instructions that when executed enable a processor to:
request load information associated with one or more connections adapted to transmit data from a base station to a remote location, wherein the request is encapsulated in a data packet;
receive the load information; and
display the load information associated with the one or more connections in substantially real-time.

11. The article of claim 10, wherein the instructions when executed enable the processor to receive the load information over an Internet protocol network.

12. The article of claim 10, wherein the instructions when executed enable the processor to display the load information in a graphical form.

13. The article of claim 10, wherein one or more access terminals are capable of communicating with the base station, and wherein the instructions when executed enable the processor to display a current transmission rate of at least one of the access terminals in substantially real-time.

14. The article of claim 10, wherein the base station is configured to support a three-sector configuration, wherein the instructions when executed enable the processor to display a transmission rate of at least one of the three sectors in substantially real-time.

15. The article of claim 10, wherein the instructions when executed enable the processor to display load information associated with the one or more connections of a second base station substantially in real-time.

16. A method, comprising:
determining usage as a function of capacity of two or more connections that are adapted to transmit data to a remote location; and
displaying a usage for at least one of the two or more connections in substantially real-time.

17. The method of claim 16, wherein a base station is communicatively coupled to the two or more connections, and wherein determining the usage comprises:
providing a request to the base station to provide the usage of the two or more connections over an Internet Protocol; and
receiving the usage of the two of more connections over the Internet Protocol.

18. A communications system, comprising:
a router;
a base station communicatively coupled to the router by one or more connections; and
a control unit adapted to:
determine a load level of the one or more connections that are adapted to transmit data to a remote location; and
display a usage for at least one of the two or more connections in substantially real-time.

19. The system of claim 18, wherein the control unit is adapted to provide a request to the base station to provide the load level of the one or more connections over an Internet Protocol.

20. The system of claim 18, further comprising a mobility server adapted to provide at least one of a user data rate and sector data rate over an Internet Protocol to the control unit.
